(19) United States
(12) Patent Application Publication
(10) Pub. No.: US 2003/0010908 A1
(43) Pub. Date: Jan. 16, 2003

(54) Conductive card suitable as a MALDI-TOF target

(76) Inventors: Phillip Clark, Wakefield, MA (US); Cheryl Brucato, Andover, MA (US); David Brewster, Beverly, MA (US); Rick Garretson, Stratham, NH (US); William Kopaciewicz, West Newbury, MA (US); Robert Spillman, Boxford, MA (US)

Correspondence Address: Kevin S. Lemack, Nields & Lemack, Suite 8, 176 E. Main Street, Westboro, MA, 01581, US

(21) Appl. No.: 09/897,181

(22) Filed: Jul. 2, 2001

(51) Int. Cl. H01J 49/04

(52) U.S. Cl. 250/288

(57) ABSTRACT

Sample presentation device for mass spectrometry, preferably MALDI time-of-flight spectrometry. The sample presentation device of the present invention is composed of a material that has surface electrical conductivity. The surface of the sample presentation device can be rendered electrically conductive in a variety of ways. It is adapted to be removably insertable into a spectrometer, such as a spectrometer tube, for presenting the sample (usually together with a matrix for promoting desorption and ionization of the sample molecules)

### BACKGROUND OF THE INVENTION

Matrix-assisted laser desorption/ionization (MALDI) analysis is a useful tool for solving structural problems in biochemistry, immunology, genetics and biology. Samples are ionized in the gas phase and a time of flight (TOF) analyzer is used to measure ion masses. TOF analysis begins when ions are formed and are accelerated to a constant kinetic energy as they enter a drift region. They arrive at a detector following flight times that are proportional to the square root of their masses. A mass spectrum is created because ions of different mass arrive at the detector at different times.

Mass spectrometry can be a powerful tool in the fields of drug discovery and development, genotyping, and proteome research. Using MALDI mass spectrometry, amino-acid residue specific and sequence information about protein products produced both naturally and recombinantly can be obtained, and thus applications in peptide mapping, proteins and peptides sequencing have become common. Current trends in research are to analyze larger and larger numbers of samples using automated handling equipment. Quantities of individual samples are from the micro-mole levels to ato-mole levels. As a result, sample are also becoming smaller and a need exists for sample handling formats to be miniaturized, be of high density and disposable.

In a typical MALDI TOS MS operation, the sample to be analyzed is spotted on a metal plate (often termed the target or sample presentation device), reagents are added (matrix) that support ionization, and then they are dried to form crystals. In these instruments, the sample is positioned on an X-Y stage so that the operator can center the sample in the field for analysis. A high voltage potential is maintained between the target and a metal grid. This voltage can be maintained or pulsed, depending upon the desired results and a vacuum is created in the chamber. A laser is fired into the sample/matrix and a plume of ions are formed. The voltage difference is used to accelerate the ions up a flight tube so that they can be analyzed. The analysis directly relates the time of flight to the mass of the ionized component.

Several parameters can effect the quality of the results, including flatness of the target, amount and type of matrix, concentration of the sample, conductivity of the sample target, as well as other variables.

When multiple samples are applied, the flatness of the target is critical to the accuracy of the mass reads. In the simplest mode, the system relies on default standards in the analysis software to correlate flight times to mass. If the surface of the target is not flat, the flight length will change from sample position to sample position, and the change in flight length will result in a change in flight time and thus the determined mass. This variation can be overcome by using internal standards mixed into each sample. Also, a standard placed near enough to each sample can be used so as to minimize any variations due to lack of flatness.

The more concentrated the sample, the greater the signal will be relative to the background or system noise. Data with a high signal-to-noise ratio are always desirable with analytical instruments. When using the metal target, the researcher pipettes the sample onto the target by hand or with automated liquid handlers. The less spreading of the sample causes a higher density of crystal formation in the area, resulting in a greater signal-to-noise ratio. One means by which the signal can be enhanced is by chemically creating small hydrophilic regions (dots) onto a metal target surface that has been (chemically) renderd hydrophobic. A small amount of sample/matrix is dispensed on the hydrophilic spot, and as the sample evaporates, it remains centered on the spot and concentrates forming a dense deposition of crystals. The AnchorChip commercially available from Bruker is such a target.

The conductivity of the sample target effects the sharpness of the signal peak. If the target is conductive, the free flow of electrons ensures a complete and constant electrical discharging of the sample. The conductivity provides a circuit for replenishing the charge. If the target is not conductive, a static charge will build up, which can effect the ion plume formation. This disruption in the plume results in broad peaks. The broadening of the peaks results in a loss of peak resolution and masking of small adjacent peaks. This is undesirable, since the goal of mass spectrometry is to determine all of the masses of the component being analyzed.

It is therefore an object of the present invention to provide the highest resolution for the MALDI TOF mass spectrometric analysis of samples.

It is a further object of the present invention to provide a low cost, disposable sample presentation device for mass spectrometry.

It is yet a further object of the present invention to provide a MALDI time-of-flight sample presentation device that is non-metallic and has adequate conductivity.

### SUMMARY OF THE INVENTION

The problems of the prior art have been overcome by the present invention, which provides a sample target or presentation device for preferably MALDI time-of-flight spectrometry mass spectrometry. The sample presentation device of the present invention is composed of a non-metallic or non-conductive material, preferably plastic, that has surface electrical conductivity. The surface of the sample presentation device can be rendered electrically conductive in a variety of ways. It is adapted to be removable insertable into a spectrometer, such as a spectrometer vacuum chamber, for presenting the sample (typically) together with a matrix for promoting desorption and ionization of the sample molecules.

### BRIEF DESCRIPTION OF THE DRAWINGS

FIG. 1 is the MALDI TOF mass spectrum of a peptide mixture using a metallic target;

FIG. 2 is the MALDI TOF mass spectrum of a peptide mixture using a glass fiber reinforced polypropylene target;

FIG. 3 is the MALDI TOF mass spectrum of a peptide mixture using a polypropylene target treated with a surface coating;

FIG. 4 is the MALDI TOF mass spectrum of a peptide mixture using a polypropylene target treated with a surface coating;

FIG. 5 is the MALDI TOF mass spectrum of a peptide mixture using a metallic target;

FIG. 6 is the MALDI TOF mass spectrum of a peptide mixture using a glass fiber reinforced polypropylene target;

FIG. 7 is the MALDI TOF mass spectrum of a peptide mixture using a polypropylene target containing a conductive additive; and

FIG. 8 is the MALDI TOF mass spectrum of a peptide mixture using a polypropylene target containing a conductive additive.

### DETAILED DESCRIPTION OF THE INVENTION

Suitable materials of construction for the sample presentation device of the present invention are not particularly limited, and include plastics such as polyethylene, polypropylene, polystyrene, polycarbonate, copolymers thereof, glass, suchas glass fiber reinforced polyolefin, and metal (which can be roughed). The materials used should not interfere with the operation of the device or the chemicals or reagents to be used in the procedure. Inherently conductive polymers also can be used, with the surface conductivity enhanced in accordance with the present invention. Polyolefins, and particularly polypropylene thermoplastics, are preferred materials. Suitable configurations are also not particularly limited, although generally for MALDI applications, the configuration of the sample presentation device must be of dimension that is compatible with the instrument. For the Applied Biosystems Voyager® MS the dimensions are 2.24×2.26×0.06 inches. The sample presentation device preferably has a sample presentation surface that is planar to help ensure uniform presentation of a plurality of samples to the laser.

Electrical conductivity can be added to the sample presentation device of the present invention by a variety of techniques. For example, carbon particles, carbon fibers, metal coated glass spheres, metal particles (including shards, fibers, fibers, irregular shapes, etc.) or combinations thereof can be added to the plastic resins. Alternatively or in addition, one or more surfaces of the sample presentation device can be coated with conductive materials, such as conductive paints. Metal can be deposited using vacuum deposition. A metal film can be laminated to one or more surfaces, or conductive inks can be printed on one or more surfaces. Preferably, graphite particles are incorporated into the presentation device or a metallic monolayer (such as gold-palladium) is applied to at least one surface of the device such as by sputter coating. The sputter coating thickness is on the atomic level, and is about 10 nanometers.

The preferred technique for providing conductivity is coating with graphite paint. One exemplary formulation is as follows:

5-10% (w/w %) polystyrene resin

20-40% M-Pyrol

0-15% Dimethylacetamide

0-25% Isopropanol

0-20% Acetone

0-15% t-Butyl alcohol

10-20% Ethyl acetate

5-15% Dipropyleneglycol methylether

8-20% microgranular graphite

The resulting paint can be applied to the surface of the sample presentation device in a variety of ways. For example, it can be airbrushed evenly onto the surface, dried in an oven at 60° C. for 30-90 minutes, followed by extraction in a room temperature methanol bath for 30-60 minutes and air-dried. It can then be returned to the oven and annealed at 60° C. for 30-90 minutes. The resulting surface may be polished with a paper towel or cloth. A coating thickness of from about 0.001″ to about 0.003″ is suitable.

A further representative example of imparting surface electroconductivity can be accomplished by sputter coating gold-palladium particles onto a plastic sample presentation substrate.

The amount of conductivity to be added to the sample presentation device of the present invention should be sufficient to impart surface resistance in an amount less than about 1500 ohms per square inch, preferably less than 500 ohms per inch. A graphite coating thickness of from about 0.001 to about 0.003 inches has been found to be suitable to provide resistivity less than 500 ohms per square inch. The sample presentation device of the present invention generally includes a matrix additive to promote the crystallization and subsequent ionization of the sample or analyte molecules upon exposure to a light source such as laser radiation. Such matrix additives are known to the skilled artisan, and are typically physically deposited or chemically bonded to the surface of the sample presentation device.

### EXAMPLE 1

Polypropylene substrates (2.24×2.26×0.06 inches) were affixed to a vertical support in a fume hood. Using a common hobbyist airbrush (pressurized to 50 psi), the substrates were spray painted with a fine mist of graphite loaded lacquer of the following composition:

6% (w/w %) polystyrene (Dow Styron 685D)

20% (2/2%) graphite (1-2 μm) (Aldrich #28286-3)

10% Isopropanol

20% Ethyl acetate

44% N-methyl-pyrroldone

After a thin consistent coating was applied, the substrates were placed in an oven at 60° F. for 30 minutes. They were then extracted in a room-temperature methanol bath for 30 minutes and air-dried.

Using an Ohmmeter with probes clamped on each side, the surface resistance went from essentially infinite on a bare plastic substrate to about 190 Ohms/in² with the coated substrate.

### EXAMPLE 2

Polypropylene MALDI TOF MS substrates (2.24×2.26×0.06 inches) were inserted into a vacuum chamber of a lab sputter coating unit (SPI Module System). The chamber was pumped down to a vacuum of 9×10⁻² millibar. A current of 6 milliamps was applied for one minute to the exposed top surface of the substrate to deposit gold palladium. After this period, the chamber was vented to atmosphere. Upon removal of the device, discoloration of the substrate surface was observed.

Using an Ohmmeter with probes clamped on each side, the resistance went from essentially infinite on a bare plastic substrate to about 770 Ohms/in² with the coated substrate.

### EXAMPLE 3

### Influence of Conductive Surface Coating

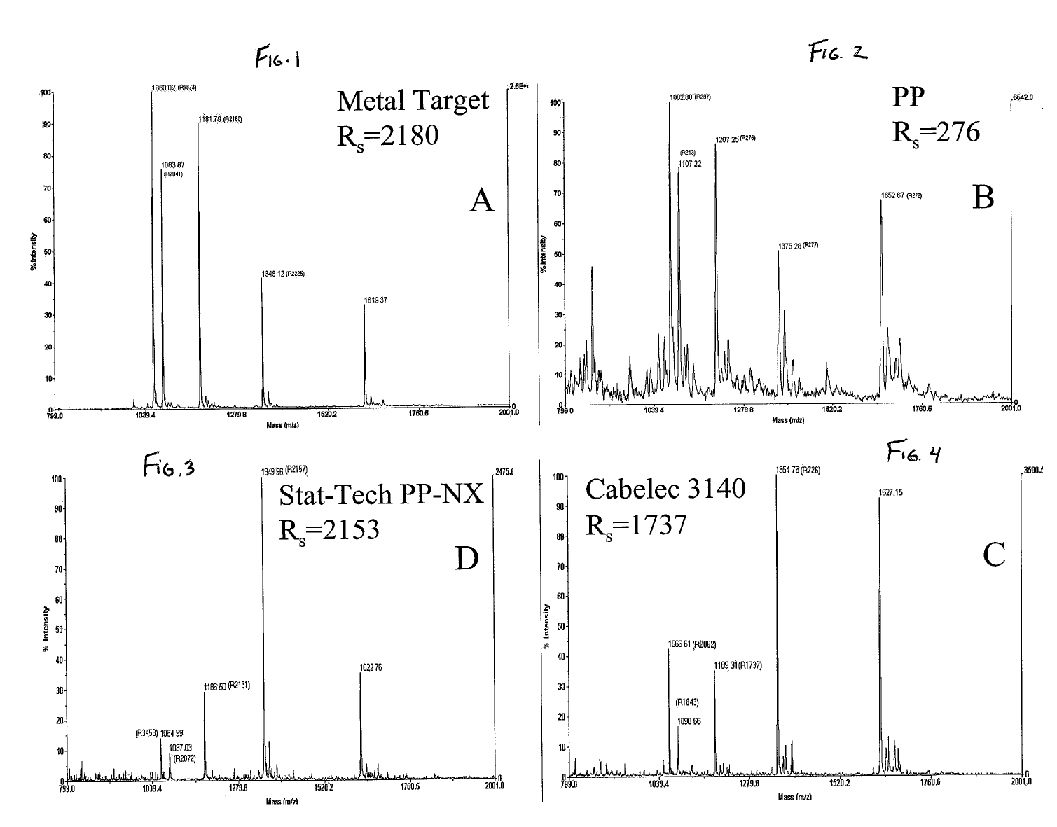

FIGS. 1 through 4 demonstrate the influence of increasing the surface conductivity of a non-metallic MALDI Target by way of a coating. FIG. 1 is the mass spectrum of a peptide mixture (Table 1) obtained from a metallic target using an Applied Biosystems Voyager® DE MALDI TOF MS in linear mode. It is indicative of expected performance. FIG. 2 is a spectrum of the same peptides taken from a target composed of glass fiber reinforced polypropylene (essentially non-conductive). Note the relative loss in resolution. FIGS. 3 & 4 are spectra taken from polypropylene targets that have been treated with a surface coating to improve surface conductivity. The spectrum in FIG. 3 was taken from a gold-palladium sputter coated polypropylene target. The mass spectrum in FIG. 4 was taken from a polypropylene target that was coated with graphite paint. Note the improvement in resolution relative to FIG. 2.

### EXAMPLE 4

### Influence of Conductive Plastic

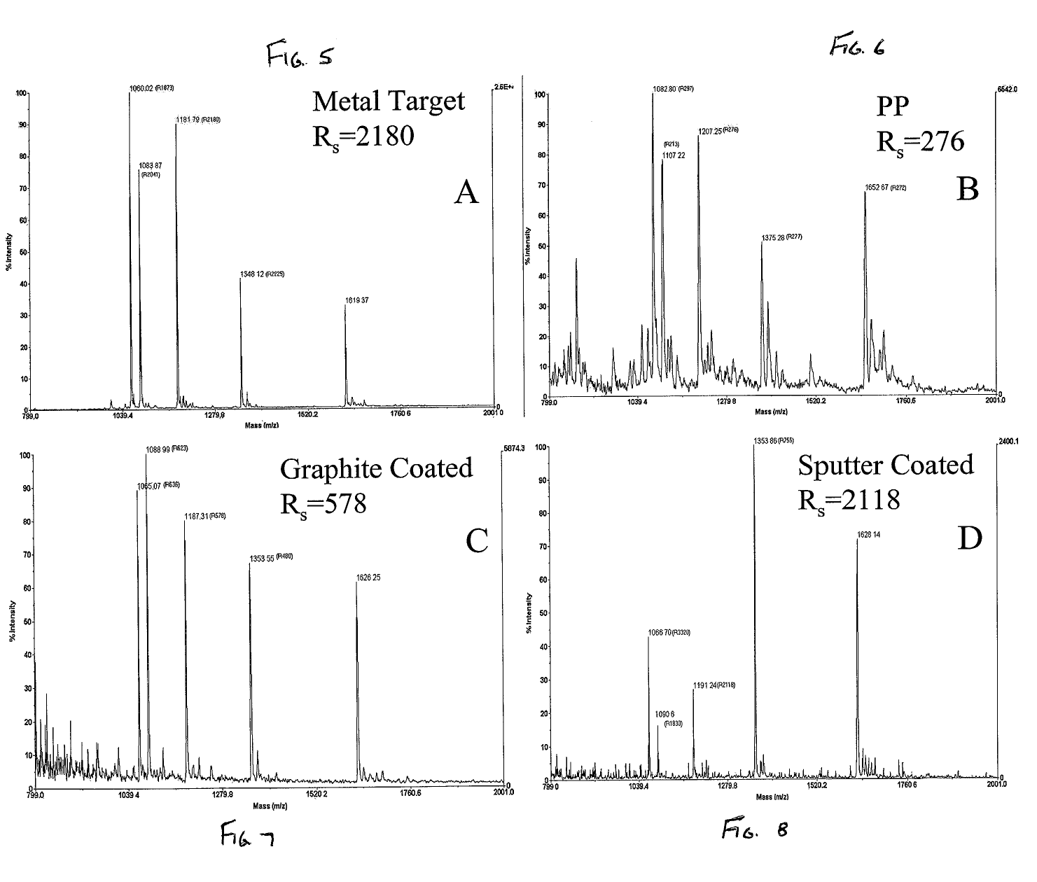

FIGS. 5 through 8 demonstrate the applicability using conductive plastic resins as non-metallic MALDI Targets. FIG. 5 is the mass spectrum of a peptide mixture (Table 1) obtained from a metallic target using an Applied Biosystem Voyager® DE MALDI TOF MS. It is indicative of expected performance. FIG. 6 is a spectrum of the same peptides taken from a target composed of glass fiber reinforced polypropylene (essentially non-conductive). Again note the relative loss in resolution. FIGS. 7 & 8 are spectra taken from two targets formed from polypropylene thermoplastics that contain a conductive additive. The spectrum in FIG. 7 was taken for a target made from Cabelec 3140 resin from Cabot Plastics (Belgium). The data in FIG. 8 were obtained on a target composed of Stat-Tech PP-NX resin from MA Hanna Engineered Plastics (Lemont, Ill.). Again note how resolution improved on the conductive plastic targets.

TABLE 1
Peptide Identification

| Peptide | MW +/− 10 |
|---|---|
| Oxytocin | 1007.2 |
| Bradykinin | 1060.2 |
| [Arg⁸]-Vasopressin | 1084.2 |
| LHRH | 1182.3 |
| Substance P | 1347.6 |
| Bombesin | 1619.9 |

TABLE II
Surface Resistance and Spectral Resolution

| | Surface | |
|---|---|---|
| | Resistance | |
| Target Composition | KΩ/in² | Resolution |
| Stainless Steel | 0 | 2180 |
| PolyPropylene | ∞ | 276 |
| Sputter Coated | 0.77 | 2118 |
| Polypropylene | | |
| Graphite Coated | 0.19 | 578 |
| Polypropylene | | |
| Stat-Tech PP-NX | 0.99 | 1737 |
| MA Hanna Engineered Materials | | |
| Lemont, IL | | |
| Cabelec 3140 | 1.13 | 2131 |
| Cabot Plastics | | |
| Belguin | | |

What is claimed is:

1. A sample presentation device for analysis of a sample by matrix-assisted laser desorption/ionization time-of-flight mass spectrometry, said device comprising a substrate having a planar surface to which electrically conductivity has been imparted such that the resistance on said planar surface is less than about 1500 ohms per square inch.

2. The sample presentation device of claim 1, wherein said electrical conductivity is imparted by coating said surface with a graphite paint.

3. The sample presentation device of claim 1, wherein said coating is 0.001 to 0.003 inches thick.

4. The sample presentation device of claim 1, wherein said substrate is selected from the group consisting of polypropylene, polyethylene, polystyrene, polycarbonate and glass fiber/resin.

5. The sample presentation device of claim 1, wherein said surface is coated with a metal.

6. The sample presentation device of claim 5, wherein said surface is sputter coated.

7. The sample presentation device of claim 5, wherein said metal comprises gold-palladium.

8. The sample presentation device of claim 4, wherein said electrical conductiviy is imparted by a conductive filler added to the resin.

9. The sample presentation device of claim 8, wherein said conductive filler is selected from the group consisting of carbonized particles, metallized glass spheres and metal filings.

10. A system for analyzing a sample, comprising:
an energy source that emits laser light;
a substrate having a planar surface to which electrically conductivity has been imparted such that the resistance on said planar surface is less than about 1500 ohms per square inch, said planar surface being adapted to present said sample to said energy source for ionization; and
a detector in communication with said planar surface for detecting ions produced by said ioniziation.

11. The system of claim 10, wherein said sample is presented in combination with a matrix.
